(19) United States
(12) Patent Application Publication
(10) Pub. No.: US 2016/0028699 A1
(43) Pub. Date: Jan. 28, 2016

(54) ENCRYPTED NETWORK STORAGE SPACE

(71) Applicant: JUMPTO MEDIA INC., Toronto (CA)

(72) Inventors: Alexander AMBROZ, Haliburton (CA); Necj PALIR, Celje (SI)

(21) Appl. No.: 14/775,000

(22) PCT Filed: Mar. 13, 2014
(86) PCT No.: PCT/CA2014/000208

§ 371 Date: Sep. 11, 2015

Related U.S. Application Data
(60) Provisional application No. 61/779,984, filed on Mar. 13, 2013.
(60) Provisional application No. 61/804,501, filed on Mar. 22, 2013.

(51) Int. Cl. H04L 29/06; H04L 9/32

(52) U.S. Cl. CPC H04L 63/0428; H04L 9/3242; H04L 63/083; H04L 2209/24

(57) ABSTRACT

A unique storage space is associated with a unique identifier. A remote device (such as a server, computer, smartphone, etc.) receives from a client device the unique identifier and a user password. The remote device generates an encryption key specific to the unique storage space using the unique identifier and the user password, encrypts data received from the client device using the encryption key and stores encrypted data in the unique storage space, decrypts data requested by the client device using the encryption key and sends decrypted data to the client device, and deletes the encryption key as well as any unencrypted data and decrypted data.

### CROSS-REFERENCE TO RELATED APPLICATIONS

This application claims priority to US provisional applications 61/779,984, filed Mar. 13, 2013, and 61/804,501, filed Mar. 22, 2013, the contents of which are incorporated herein by reference.

### FIELD

The present invention relates to encrypted storage.

### BACKGROUND

A virtual “cloud” network refers to a collection of hardware and software resources that are provided and maintained by third parties and are accessible by users over data communication networks, which include wired and wireless networks with access to the Internet. A variety of methods have been proposed and implemented to secure private data stored on remote devices and computers connected to the Internet. Conventional cloud data storage solutions include unencrypted or encrypted storage. The encrypted storage solutions can include disk encryption or file encryption, both of which utilize encryption keys to secure the data. Remote devices and computers that contain encrypted storage solutions are accessible to and are maintained by system administrators. System administrators and computer systems control encryption keys, typically stored in databases, in order to decrypt or read any secured data. Users of remote data storage solutions can typically access their data contained in devices and computers connected to the Internet with the use of login credentials and passwords. Users typically do not maintain or control the encryption keys for their data. Most remote data storage solutions are primarily utilized by consumers and businesses who want to securely store their private data in remote locations accessible over the Internet. Typical secure data storage solutions contain many potential security concerns where there is a need to (a) securely store data on remote devices and computers controlled by system administrators and computer systems, and (b) securely access private data and databases on remote devices and computers maintained by system administrators and computer systems.

For instance, Lumme-Maki-Vepsalainen (U.S. Pat. Application US20130019299 A1) teach a method that includes, in response to a need to access for a user certain stored data that requires authentication, sending a request for the stored data into a data cloud, the request not identifying the user. Although Lumme-Maki-Vepsalainen provide security enhancements by eliminating the need to identify users attempting to access their remote data storage, there remains a need for a more secure encrypted data storage without the ability of system administrators to: (a) create or store encryption keys and (b) decrypt or read any secured data. There is also a need for increased security and anonymity when remotely accessing data and databases on devices and computers connected to the Internet.

### SUMMARY

According to one aspect of the present invention, a method of storing encrypted data at a remote device (such as a server, computer, smartphone, etc.) includes transferring a unique identifier and a user password from a client device to the remote device via a network, the unique identifier specific to a unique storage space. The method further includes the remote device generating an encryption key specific to the unique storage space using the unique identifier and the user password, transferring unencrypted data from the client device to the unique storage space, encrypting the unencrypted data by the remote device using the encryption key to generate encrypted data, storing the encrypted data in the unique storage space, and deleting the unencrypted data and the encryption key from the remote device.

According to another aspect of the present invention, a method of retrieving data from a remote device includes transferring a unique identifier and a user password from a client device to the remote device via a network, the unique identifier specific to a unique storage space. The method further includes the remote device generating an encryption key specific to the unique storage space using the unique identifier and the user password, decrypting encrypted data by the remote device using the encryption key to generate decrypted data, transferring the decrypted data from the unique storage space to the client device, and deleting the decrypted data and the encryption key from the remote device.

According to another aspect of the present invention, a device (such as a server, computer, smartphone, etc.) for storing encrypted data includes storage defining at least one unique storage space, the at least one unique storage space associated with a unique identifier. The device further includes a network interface controller for connection to a client device via a network. The device further includes an encryption engine configured to receive from the client device the unique identifier and a user password, generate an encryption key specific to the unique storage space using the unique identifier and the user password, encrypt data received from the client device using the encryption key and store encrypted data in the unique storage space, decrypt data requested by the client device using the encryption key and send decrypted data to the client device, and delete the encryption key, unencrypted data, and decrypted data.

### BRIEF DESCRIPTION OF THE DRAWINGS

Embodiments of the present invention will now be described, by way of example only, with reference to the accompanying drawings, in which:

FIG. 1 is a block diagram of software components;

FIG. 2 is a block diagram of hardware components;

FIG. 3 is a process diagram of creating a unique encrypted cloud and data storage;

FIG. 4 is a process diagram of authenticating to a unique encrypted cloud and data storage;

FIG. 5 is a process diagram of encrypting and storing the data on a unique encrypted cloud; and

FIG. 6 is a process diagram of decrypting and reading the data from a unique encrypted cloud and data storage.

### DETAILED DESCRIPTION

The present invention relates to encrypted data storage on remote devices and computers connected to the Internet. More particularly, the invention concerns creating and protecting data storage and databases on remote devices and computers in virtual cloud networks. More particularly, the invention can provide secure and anonymous access to encrypted data storage and databases within virtual cloud networks.

The present invention can provide for securely creating and accessing encrypted data storage on remote devices and computers, without encryption keys that are accessible to any person or system. A secure mechanism for creating and accessing encrypted data storage permits users to (a) securely create encrypted data storage on remote devices and computers, (b) maintain control over the information needed to create the encryption keys away from the remote devices and computers, and (c) securely and anonymously access remotely stored encrypted data. The combined use of these processes allows for the creation of secure encrypted data storage that can only be accessed and maintained by the user that initiated the creation of such user's encrypted data storage on remote devices or computers connected to the Internet.

The present invention can provide users of remote data storage solutions with sole ownership of and access to the information that is required to create their private encryption keys as part of their authentication session during their remote access to their encrypted data storage. More particularly, a user's private encryption keys are never stored in any database for access by systems administrators or computer systems. The encryption keys are generated by the system in real-time during the user-initiated process of encryption and decryption—these processes require explicit user permission and can only be triggered by the specific user's request.

The present the invention can provide users with complete control of their encrypted data saved on remote devices and computers connected to the Internet by storing their encrypted data values in the database and their encrypted files in the cloud storage space, for complete data privacy and security, including all system and logs. The invention can provide secure access to the user's encrypted data through a secure authentication process on the remote storage device or computer. Upon successful authentication, users can store data files in the encrypted cloud storage space or data values in the encrypted cloud database. The encrypted cloud database and encrypted cloud storage can be utilized by other system-authorized applications or apps that are available on the remote devices or computers. Applications include browsing and downloading apps, secure file sharing apps, secure e-mail apps, and secure text, voice and video apps. These cloud-based applications can securely store encrypted data values such as encrypted user history and logs, encrypted user emails, and encrypted user chat, voice and video logs for complete privacy of user data. The invention can provide users complete control over access to their data that resides in the encrypted storage solution on remote devices and computers connected to the Internet and in virtual cloud networks.

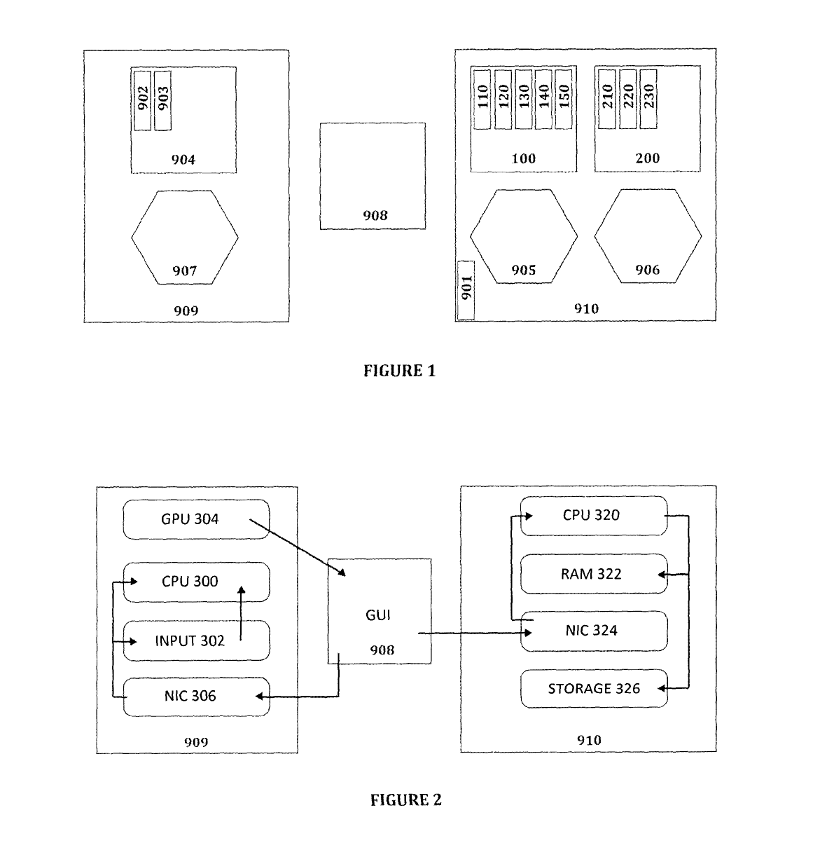

Referring now to the invention in more detail, in FIG. 1 and FIG. 2 there are shown plurality of software and hardware components, respectively, which can be used to implement embodiments of the invention:
100—Encryption Engine
110—Generate Encryption and Decryption Key
120—Encrypt Data
130—Decrypt Data
140—Generate Cryptographic Hash
150—Generate Unique Cloud Identification
200—Cloud Authentication Engine
210—Create Unique Encrypted Cloud Storage Space
220—Authenticate to Unique Encrypted Cloud
230—Create Authentication Session
300—Processor
302—Input device
304—Graphics processor
306—Network interface controller
320—Processor
322—Memory
324—Network interface controller
326—Storage device
901—Personal Encryption Key
902—Personal Access Password
903—Unique Cloud Storage Identification
904—Authenticated Session
905—Cloud Computer Database
906—Cloud Computer Storage Space
907—Input Data
908—Graphical User Interface (GUI)
909—Client Device or Computer
910—Server Computer

With reference to FIG. 2, the client device 909 can include a processor (e.g., CPU) 300, an input device 302, a graphics processor (e.g., GPU) 304, a network interface controller 306, and memory (not shown). The server 910 can include a processor (e.g., CPU) 320, random-access memory (RAM) 322, a network interface controller 324, and a storage device 326 operating as a cloud computer database 905, cloud computer file storage 906, or the like. The server 910 is an example of a remote device, and other examples of remote devices include computers, mobile devices (e.g., smartphones), and similar.

Referring to the embodiments of FIG. 1 and FIG. 2, initially, unique encrypted cloud storage space is created 210 by users accessing remote server computers 910. The encryption keys 110 are generated and utilized during runtime when required and requested by users. Encryption keys 110 are preferably never stored anywhere and are not accessible by any person or system; encryption keys 110 temporarily reside in memory during encryption and decryption of data or databases. Authenticated users can securely store (a) data files in the encrypted cloud computer storage space 906 and (b) data values in the encrypted cloud computer database 905, while system administrators and computer systems cannot read or access the encryption keys 110 and cannot read or access the encrypted data.

In further detail, still referring to the embodiments of FIG. 1 and FIG. 2, the invention permits users to create unique encrypted cloud storage 210, from client devices or computers 909, within the Graphical User Interface (GUI) 908 with access to remote server computers 910. The GUI 908 that can access remote server computers 910 is typically accessible via integrated websites, web-based applications, desktop software or mobile software. The GUI 908 is a front end graphic environment in which users interact with the unique encrypted cloud storage 210. The GUI 908 can be integrated into websites, web-based applications, desktop software or mobile software. Users create their unique encrypted cloud storage 210 and can access their private data with the authenticated session 230 by the unique cloud authentication 220 within the GUI 908. The authentication session 230 contains the data that is used to encrypt and decrypt user data. A successful authentication session 230 lets users store private files to the encrypted cloud computer storage space 906 or data values in the encrypted cloud computer database 905. With successful authentication sessions 230 users can store data files in the encrypted cloud computer storage space 906 or data values in the encrypted cloud computer database 905. The encrypted cloud computer database 905 and encrypted cloud computer storage space 906 can be utilized by other system-authorized applications or apps that are available on the connected devices or computers in a virtual cloud network. The storage and encryption of a file in the unique encrypted cloud storage 210 begins with the transfer of the file as triggered by the user in the GUI 908. Once the file is transferred to the server computer 910, it is stored in a temporary variable “A”. The temporary variable “A” is encrypted using the encryption engine 100 as described in the encrypt data process 120. Once the encrypted value is returned, it is stored in the encrypted cloud computer storage space 906 while the unencrypted value from variable “A” is emptied and deleted from the server computer system memory 910. The encrypted file is stored in the encrypted cloud computer storage space 906 and can only be accessed and decrypted by the user that created it. The decryption process uses the encryption engine 100 as described in the decrypt data process 130. The storage and encryption of data values in the encrypted cloud computer database process 905 is substantially the same as the storage and encryption of data files in the encrypted cloud computer storage process 906, except that the values passed by users are stored and read from the encrypted cloud computer database 905 instead of the encrypted cloud computer storage 906.

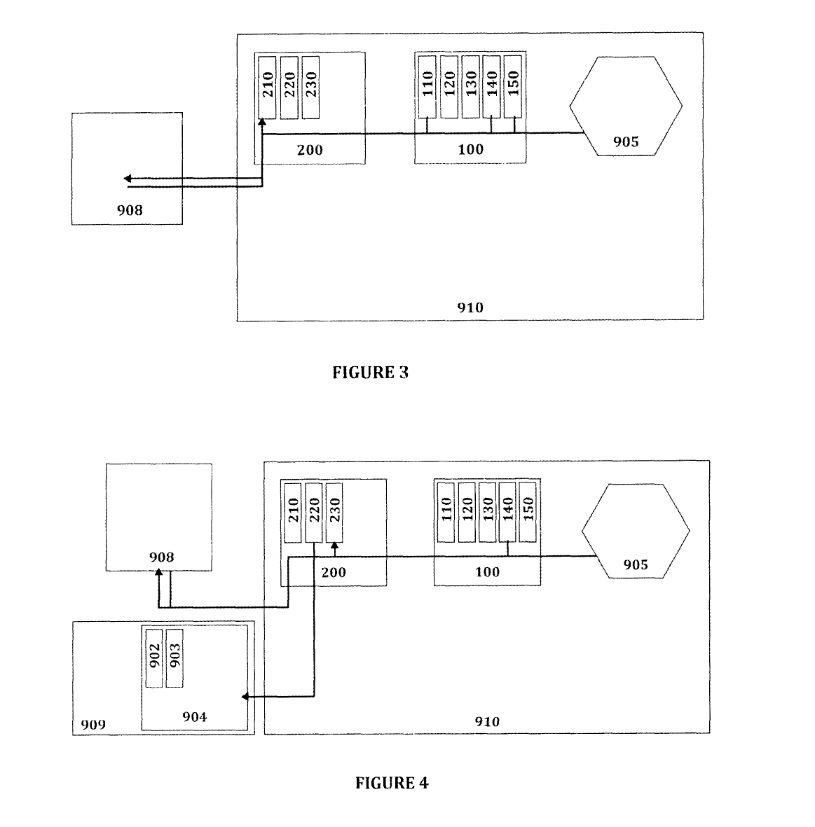

Referring now to FIG. 3, the creation of unique encrypted cloud storage 210 is triggered when the cloud authentication engine 200 receives the action command “create”, along with the required parameters “cloud name” and “password”. The cloud authentication engine 200 can be implemented as a software component or script, which is installed and running on a server computer 910. The cloud authentication engine 200 listens for commands on a specific and predetermined IP address and inbound port; it is configured to create new a unique encrypted cloud storage 210 in the cloud computer database 905 and match the (a) existing unique encrypted cloud storage in the database against the (b) cloud name and password combination query. Both parameters are received in raw form as they are entered in the GUI 908 component and they are stored to temporary variables. The GUI 908 is a front end graphic environment in which users interact with the unique encrypted cloud storage 210. The GUI 908 can be integrated into websites, web-based applications, desktop software or mobile software. Once entered, the parameters are checked; if the required parameters meet the minimum-security requirements and the minimum value length requirements, the value passed as “cloud name” is queried in the database for any existing unique encrypted clouds 210 with the same name. The “cloud name” is a unique identifier thus it is be a made a unique value; only one can exist in the same system. If no existing instance of the “cloud name” is found, the creation of the unique encrypted cloud storage 210 can begin. All values except the unique cloud storage identifier 903, also referred to as the “cloud name”, are stored in the unique cloud-specific encryption.

In the first step, the creation of unique encrypted cloud storage 210 generates unique cloud identifications 150. This value is stored in the first JSON array; JSON or “JavaScript Object Notation”, is a text-based open standard designed for data interchange, designed for representing simple data structures. The generation of the unique cloud identification 150 is triggered when the encryption engine 100 receives the command “generate unique cloud identification” 150, along with the required parameter “mouse entropy”. In the present implementation, the encryption engine process 100 uses Unix Epoch time, a 16-digit random number, and mouse entropy passed from the frontend GUI 908. The values are combined in a temporary variable “Z”. Variable “Z” gets cryptographically hashed by using the internal process 140. The generation of a cryptographic hash 140 is triggered when the encryption engine 100 receives the command “hash” along with the required parameter “value”. The value parameter is stored in a temporary variable “Z”. The value of variable “Z” is emptied and deleted from memory after the successful completion of this process. The encryption engine 100 uses one of the irreversible cryptographic hashing methods defined by, for example, the global system (SHA-2, SHA-3) to hash the value of variable “Z” and return it as the result of this process. The cloud authentication engine 200 communicates with the encryption engine 100, which generates and returns a unique cloud identification code as described in process 150.

In further detail, still referring to FIG. 3, the encryption engine 100 is a software component or script, which is installed and runs on a server computer 910. The server computer 910 stores and executes data values and data files in the storage and memory located on the server computers 910 (see FIG. 2), which interact with or are a part of the unique encrypted cloud 210. Encryption engine 100 listens for commands on a specific and predetermined IP address and an inbound port; it is configured to encrypt the user data, decrypt the user data, build and generate the encryption keys, read and write the encryption keys to the user session, and generate cryptographic hashes 140. The values of variables are emptied and deleted from memory. The returned value from generating a cryptographic hash process 140 is stored in a temporary variable “B”. The value from variable “B” is queried in the cloud computer database 905 for any existing value matches. If the unique cloud identification 150 is found in the cloud computer database 905, the generation of the unique cloud identification process 150 is looped and repeated until the generated cloud identification 150 is unique and not found in the database of existing unique encrypted clouds 210—the hashed unique value is returned as the result of this process. The unique identification value is stored in a temporary variable and is emptied from the variable after successful unique encrypted cloud 210 creation.

In the second step, the creation of unique encrypted cloud storage 210 generates the encryption key. The cloud authentication engine 200 communicates with the encryption engine 100, which generates and returns the cloud specific encryption key as described in process 110. The creation of a private encryption and decryption key 110 is triggered when the encryption engine 100 receives the action command “generate key” along with the required parameters “password” and “unique cloud identification”. If the “password” and “unique cloud identification” parameters are not passed manually, they are read from the cloud authentication session 904. The authentication session 904 contains an encrypted set of data values, which holds the data from successfully authenticated users attempting to access their unique encrypted clouds 210. The password parameters are received in the raw un-hashed form and are stored to temporary variables. The unique cloud identifications 150 are also stored to temporary variables. The raw un-hashed password and unique cloud identification 150 are combined into a single value, which is stored in a temporary variable “C”. The variable “C” is internally passed to generate a cryptographic hash described in 140. The returned value is the final result, which is the cloud-specific encryption key. The combination of the “password” and “unique cloud identification” are configured to produce the same encryption key. The result of this function is not stored in the session, database or any other permanent storage; it is deleted from memory at process completion. The encryption key is stored in a temporary variable and is emptied from the variable after successful unique encrypted cloud 210 creation. Encryption keys are not stored at any point.

In the third step, the creation of unique encrypted cloud storage 210 generates an irreversible hash value of the cloud access password. This value is stored in the first JSON array. The cloud authentication engine 200 communicates with the encryption engine 100, which generates and returns the hash value of the “cloud password” as described in process 140. The hashed value is stored in a temporary variable and is emptied from the variable after successful cloud creation.

In the fourth step, the creation of unique encrypted cloud storage 210 creates two separate JSON data arrays. The first array contains system specific, insensitive and required information, which can be read by the system; it includes values such as “cloud name”, “unique cloud identification”, “date created”, “hashed password” and other insensitive data. The second array is empty and is encrypted by the encryption engine as described in process 110. It serves as a secure and encrypted space for future data, which will be stored in it. The first array and the second encrypted array of data are stored in the database, which creates a unique encrypted cloud. All the variables are emptied and their content is destroyed.

Referring now to FIG. 4, the authentication to a unique encrypted cloud 220 is triggered when the cloud authentication engine 200 receives the action command “authenticate” along with the required parameters “cloud name” and “password”. Both parameters are received in the raw form as they were entered in the GUI 908 component and are stored to temporary variables. The GUI 908 is a front end graphic environment in which users interact with the unique encrypted cloud storage 210. The GUI can be integrated into websites, web-based applications, desktop software or mobile software. Once entered into the GUI 908, the parameters are checked; if the required parameters meet the minimum-security requirements and minimum value length requirements, the authentication access to a unique encrypted cloud process 220 continues or it fails if otherwise.

In the first step, the authentication to a unique encrypted cloud 220 generates an irreversible hash value of the unique encrypted cloud access password. The cloud authentication engine 200 communicates with the encryption engine 100, which generates and returns the hash value of the “cloud password” as described in process 140. The encryption engine 100 is a software component or script, which is installed and runs on a server computer 910. Encryption engine 100 listens for commands on a specific and predetermined IP address and an inbound port; it is configured to encrypt the user data, decrypt the user data, build and generate the encryption keys, read and write the encryption keys to user sessions and generate cryptographic hashes 140. The generation of a cryptographic hash 140 is triggered when the encryption engine 100 receives the command “hash” along with the required parameter “value”. The value parameter is stored in a temporary variable “Z”. The value of variable “Z” is emptied and deleted from memory after the successful completion of this process. The encryption engine 100 uses one of the irreversible cryptographic hashing methods defined by, for example, the global system (SHA-2, SHA-3) to hash the value of variable “Z” and return it as the result of this process. The values of variables are emptied and deleted from memory. The hashed value is stored in a temporary variable and is emptied from the variable after successful unique encrypted cloud authentication 220.

In the second step, the authentication to a unique encrypted cloud 220 queries the database for the “cloud name” and “hashed password” combination. If a match is found in the database, the authentication to a unique encrypted cloud process 220 continues or it fails if the match is not found.

In the third step, the authentication to a unique encrypted cloud 220 internally passes the “cloud name”, “cloud unique identification” and “raw value of the password” to create the authentication session 904 and to create an authentication session as described in process 230. The authentication session 904 contains an encrypted set of data values, which holds the data from successfully authenticated users attempting to access their unique encrypted clouds 210.

The process of creating an authentication session 230 is triggered when the cloud authentication engine 200 receives the action command “create session” along with the required parameters “cloud name”, “cloud unique identification” and “raw password”.

In the first step, creating an authentication session process 230 gets the globally set system value of the encryption key. The authentication sessions are preferably stored in an encrypted form. Because the sessions are stored on the client side the information in them needs to be protected at all times to prevent possible spoofing. The encryption key is a static value, which is used to encrypt and decrypt all the session values within a housing system. The encryption key is stored in a temporary variable and is emptied from the variable after successful session creation.

In the second step, creating an authentication session process 230 creates a JSON array, which will store all the session variables. The “cloud name”, “cloud unique identification” and “raw password” are stored in the JSON array and stored in a temporary variable.

In the third step, creating an authentication session 230 encrypts the array and creates the session which time expiration and validity is set by the housing system settings. This step completes the authentication session creation. When the authentication session 904 is created and stored on the client side, the authentication of the unique encrypted cloud aka “logging in” is completed.

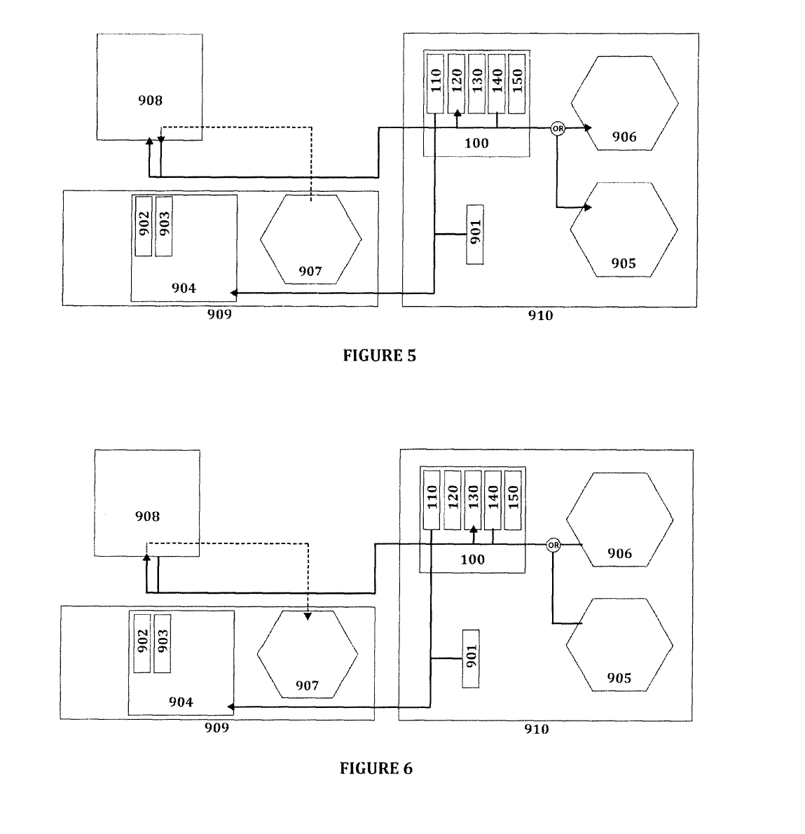

Referring now to FIG. 5, the encrypting data process 120 is triggered when the encryption engine 100 receives the action command “encrypt data” along with the required parameter “data”. The “data” parameter is an unencrypted file represented by 907, which users want to upload to their unique encrypted cloud. The input data 907 is the unencrypted form of users' data, which users want to securely store in the unique encrypted cloud. The encryption engine 100 is a software component or script, which is installed and runs on a server computer 910. The server computer 910 stores and executes data values and data files in the storage and memory located on the server computers, which are used to interact with or are a part of the unique encrypted cloud 210. Encryption engine 100 listens for commands on a specific and predetermined IP address and an inbound port. It is configured to encrypt the user data, decrypt the user data, build and generate the encryption keys, read and write the encryption keys to user sessions and generate cryptographic hashes 140. The data parameter is stored in the temporary variable “A” and emptied after successful completion of data encryption.

In the first step, the encrypting data process 120 stores the data from the client side session in a temporary variable, which provides access to the “unique cloud identification”, “raw password” and “cloud name”. It internally communicates with the process 110 to generate the unique cloud encryption key as described in 110. The process of creating a private encryption and decryption key 110 is triggered when the encryption engine 100 receives the action command “generate key” along with the required parameters “password” and “unique cloud identification”. If the “password” and “unique cloud identification” parameters are not passed manually, they are read from the cloud authentication session 230. The password parameter is received in the raw un-hashed form and it is stored to a temporary variable. The unique cloud identification 903 is also stored to a temporary variable. The raw un-hashed password and unique cloud identification 903 are combined into a single value, which is stored in a temporary variable “C”. The variable “C” is internally passed to generate a cryptographic hash described in 140. The process of generating a cryptographic hash 140 is triggered when the encryption engine 100 receives the command “hash” along with the required parameter “value”. The value parameter is stored in a temporary variable “A”. The value of variable “A” is emptied and deleted from memory after the successful completion of this process. The encryption engine 100 uses one of the irreversible cryptographic hashing methods defined by, for example, the global system (SHA-2, SHA-3) to hash the value of variable “A” and return it as the result of this process. The values of variables are emptied and deleted from memory. The returned value is the final result, which is the cloud-specific personal encryption key 901. The personal encryption key 901 is used to encrypt and decrypt personal user data on the unique encrypted cloud. The encryption key is generated from the “unique cloud identification” 903 and “personal access password” 902. The encryption key is generated during runtime only when required and requested by the user. It is never stored anywhere but remains in memory for a duration when it is required to encrypt or decrypt data. It is emptied from memory as soon as the encryption process 120 or decryption process 130 has completed. The same combination of the “unique cloud identification” and “personal access password” always produces the same encryption key 901. If the password is changed by the user at the user's request, the encryption key 901 changes and all of the user's data already stored on the unique encrypted cloud needs to be decrypted by using the user's previous password and re-encrypted by using the user's new password. The combination of the “password” and “unique cloud identification” are configured to produces the same encryption key. The result of this function is not stored in the session, database or any other permanent storage. It is deleted from memory at process completion. Once the internal process 110 successfully generates the unique cloud encryption key, it is stored in a temporary variable “B”, which is emptied and destroyed once the encryption process 120 is completed.

In the second step, the encrypting data process 120 encrypts the variable “A” with the encryption key from variable “B” using the system defined encryption algorithm (for example, AES, RSA, Serpent, Two-fish). The encrypted data is returned and stored either in cloud computer storage space 906 or cloud computer database 905, depending on the preference. The cloud computer database 905 is an SQL or NO-SQL database running on a series of cloud hosted servers. The cloud computer storage space 906 is a model of networked online storage servers where data is stored in virtualized pools of storage. The variables are emptied and deleted from system memory. This completes the data encryption process 120.

Referring now to FIG. 6, the decrypting data process 130 is triggered if the encryption engine 100 receives the action command “decrypt data” along with the required parameter “encrypted data”. The “encrypted data” parameter is a previously encrypted and stored file in the encrypted cloud computer storage space 906 or encrypted cloud computer database 905, depending on the file storage preference. The user can download and decrypt the file from the unique encrypted cloud 210 to the user's client device or computer 909. The client device or computer 909 represents the storage or memory located on the user's device, which is used to interact with the GUI 908; an example is the session data in any web browser. The encryption engine 100 is a software component or script, which is installed and runs on a server computer 910. The server computer 910 stores and executes data values and data files in the storage and memory located on the server computers, which are used to interact with or are a part of the unique encrypted cloud 210. Encryption engine 100 listens for commands on a specific and predetermined IP address and an inbound port. It is configured to encrypt the user data, decrypt the user data, build and generate the encryption key, read and write the encryption key to the user session and generate cryptographic hashes 140. The encrypted data parameter is stored in the temporary variable “A” and emptied after successful completion of data decryption.

In the first step, the decrypting data process 130 stores the data from the client side session in a temporary variable, which provides access to the “unique cloud identification”, “raw password” and “cloud name”. The system internally communicates with the process 110 to generate the unique cloud decryption key as described in process 110. The process of creating a private encryption and decryption key 110 is triggered when the encryption engine process 110 receives the action command “generate key” along with the required parameters “password” and “unique cloud identification”. If the “password” and “unique cloud identification” parameters are not passed manually, they are read from the cloud authentication session 904. The password parameter is received in the raw un-hashed form and it is stored to a temporary variable. The unique cloud identification 903 is also stored to a temporary variable. The raw un-hashed password and unique cloud identification 903 are combined into a single value, which is stored in a temporary variable “C”. The variable “C” is internally passed to generate a cryptographic hash described in 140. The process of generating a cryptographic hash 140 is triggered when the encryption engine 100 receives the command “hash” along with the required parameter “value”. The value parameter is stored in a temporary variable “A”. The value of variable “A” is emptied and deleted from memory after the successful completion of this process. The encryption engine 100 uses one of the irreversible cryptographic hashing methods defined by, for example, the global system (SHA-2, SHA-3) to hash the value of variable “A” and return it as the result of this process. The values of variables are emptied and deleted from memory. The returned value is the final result, which is the cloud specific encryption key 901. The personal encryption key 901 is used to encrypt and decrypt personal user data on the unique encrypted cloud. The encryption key is generated from the “unique cloud identification” 903 and “personal access password” 902. The encryption key is generated during runtime only when required and requested by the user. It is never stored anywhere but remains in memory for the duration period where it is required to encrypt or decrypt data. It is emptied from memory as soon as the encryption process 120 or decryption process 130 has completed. The same combination of the “unique cloud identification” and “personal access password” always produces the same encryption key. If the password is changed by the user at his request, the encryption key changes and all of his data already stored on the unique encrypted cloud needs to be decrypted by using the user's previous password and re-encrypted by using the user's new password. The combination of the “password” and “unique cloud identification” is configured to produce the same encryption key. The personal encryption key 901 is used to encrypt and decrypt personal user data on the unique encrypted cloud. The encryption key is generated from the “unique cloud identification” 903 and “personal access password” 902. In a present embodiment, the personal access 902 password is a vital component of the unique encrypted cloud system. The password is used to generate the unique personal encryption key as described in process 110. The personal access password is not stored on the server computer 910. The encryption key is generated during runtime only when required and requested by the user. It is not stored anywhere but remains in memory for the duration period where it is required to encrypt or decrypt data. It is emptied from memory as soon as the encryption process 120 or decryption process 130 has completed. The same combination of the “unique cloud identification” and “personal access password” always produces the same encryption key 901. If the password is changed by the user at his request, the encryption key changes and all of his data already stored on the unique encrypted cloud needs to be decrypted by using the user's previous password and re-encrypted by using the user's new password. The result of this function is not stored in the session, database or any other permanent storage. It is deleted from memory at process completion. Once the internal process 110 successfully generates the unique cloud decryption key it is stored in a temporary variable “B”, which is emptied and destroyed once the decryption process is completed.

In the second step, the decrypting data process 130 decrypts the variable “A” with the decryption key from variable “B” using the system defined encryption algorithm (for example, AES, RSA, Serpent, Two-fish). The decrypted data 907 is returned and downloaded in the unencrypted form. The variables are emptied and deleted from system memory. This completes the data decryption process 130.

Although the examples herein discuss transmitting unencrypted/decrypted data between a client device and a remote device, such as a server, computer, etc., it would be understood by one of ordinary skill in the art that transmitted data can be encrypted independently of encryption for storage at the remote device. For instance, techniques such as HTTPS or security certificates can be used to protect data as it is transmitted, as can other forms of encryption.

While the foregoing provides certain non-limiting example embodiments, it should be understood that combinations, subsets, and variations of the foregoing are contemplated. The monopoly sought is defined by the claims.

What is claimed is:

1. A method of storing encrypted data at a remote device, the method comprising:
transferring a unique identifier and a user password from a client device to the remote device via a network, the unique identifier specific to a unique storage space;
the remote device generating an encryption key specific to the unique storage space using the unique identifier and the user password;
transferring data from the client device to the unique storage space;
encrypting the data by the remote device using the encryption key to generate encrypted data;
storing the encrypted data in the unique storage space; and
deleting the data and the encryption key from the remote device.

2. The method of claim 1, further comprising creating the unique storage space by randomly generating the unique identifier and storing at the remote device an association between the unique identifier and the unique storage space.

3. The method of claim 2, wherein randomly generating the unique identifier includes calculating a hash value from at least user entropy.

4. The method of claim 3, wherein calculating the hash value comprises applying an irreversible cryptographic hash.

5. The method of claim 1, further comprising retaining the encryption key in memory at the remote device for a duration for encryption of additional data received from the client device and decryption of data requested by the client device before deleting the encryption key from the remote device.

6. The method of claim 1, wherein generating the encryption key comprises calculating a cryptographic hash of the unique identifier and the user password.

7. The method of claim 1, wherein the data is associated with one or more server-based applications accessible to the client device, and the data comprises one or more of browsing data, download data, user history or logs, email messages, chat messages, voice logs, and video logs.

8. The method of claim 1 further comprising:
storing a hashed user password at the remote device in association with the unique identifier;
when receiving the unique identifier and the user password from the client device, the remote device comparing the received user password with the stored hashed user password to authenticate the user; and
when the user is authenticated, creating an authenticated session for the user at the client device.

9. The method of claim 8, further comprising the remote device encrypting a session variable of the authenticated session using the encryption key and storing the session variable at the client device.

10. The method of claim 1, wherein transferring the unique identifier and the user password from the client device to the remote device comprises reading the unique identifier and the user password from a session variable.

11. The method of claim 1, wherein when receiving a new user password to replace the user password, the remote device decrypting stored data in the unique storage space using the encryption key and encrypting the stored data using a new encryption key generated from the new user password and the unique identifier.

12. The method of claim 1, wherein the unique storage space comprises memory for storing data files.

13. The method of claim 1, wherein the unique storage space comprises a database.

14. The method of claim 1, wherein the data is transferred from the client device to the unique storage space in unencrypted form.

15. A method of retrieving data from a remote device, the method comprising:
transferring a unique identifier and a user password from a client device to the remote device via a network, the unique identifier specific to a unique storage space;
the remote device generating an encryption key specific to the unique storage space using the unique identifier and the user password;
decrypting encrypted data by the remote device using the encryption key to generate decrypted data;
transferring the decrypted data from the unique storage space to the client device; and
deleting the decrypted data and the encryption key from the remote device.

16. A device for storing encrypted data, the device comprising:
storage defining at least one unique storage space, the at least one unique storage space associated with a unique identifier;
a network interface controller for connection to a client device via a network; and
an encryption engine configured to receive from the client device the unique identifier and a user password, generate an encryption key specific to the unique storage space using the unique identifier and the user password, encrypt data received from the client device using the encryption key and store encrypted data in the unique storage space, decrypt data requested by the client device using the encryption key and send decrypted data to the client device, and delete the encryption key and delete unencrypted data or decrypted data.

17. The device of claim 16, further comprising an authentication engine configured to create unique storage spaces by randomly generating unique identifiers and storing an association between each unique identifier and each unique storage space.

18. The device of claim 16, further comprising an authentication engine configured to store a hashed user password in association with the unique identifier, compare a received user password with the stored hashed user password to authenticate the user when receiving the unique identifier and the user password from the client device, create an authenticated session for the authenticated user at the client device.

19. The device of claim 18, wherein the encryption engine is further configured to encrypt a session variable of the authenticated session using the encryption key, and the authentication engine is configured to store the session variable at the client device.

20. The device of claim 16, wherein the encryption engine is further configured to randomly generate the unique identifier by calculating a hash value from at least user entropy.

21. The device of claim 20, wherein calculating the hash value comprises applying an irreversible cryptographic hash.

22. The device of claim 16, wherein the encryption engine is further configured to retain the encryption key in memory for a duration for encryption of data received from the client device and decryption of data requested by the client device before deleting the encryption key.

23. The device of claim 16, wherein the encryption engine is further configured to generate the encryption key by calculating a cryptographic hash of the unique identifier and the user password.

24. The device of claim 16, wherein the data is associated with one or more server-based applications accessible to the client device, and the data comprises one or more of browsing data, download data, user history or logs, email messages, chat messages, voice logs, and video logs.
